(19) United States
(12) Patent Application Publication
(10) Pub. No.: US 2006/0059882 A1
(43) Pub. Date: Mar. 23, 2006

(54) Rake-Hoe TM

(76) Inventor: Edward G. Schneider, Angola, NY (US)

Correspondence Address: PATRICIA M. COSTANZO, PATENT COPYRIGHT TRADEMARK LAW, 2960 BOWEN ROAD, ELMA, NY, 14059, US

(21) Appl. No.: 10/947,691

(22) Filed: Sep. 23, 2004

(51) Int. Cl. A01D 7/00

(52) U.S. Cl. 56/400.12

(57) ABSTRACT

A light weight, state-of-the-art, easy to use, short- and/or long-handled gardening implement providing at least raking and hoeing capabilities on a single tool head, so that there is no need to change tool heads or to add and/or delete parts. The rake part of the rake part of the tool head has an optional number of operative tines of optional length and width designed to till soil to appreciable depth. The operative hoe part of the tool head may be positioned on either or both ends of the tool head. The handle is positioned relative to the tool head and balanced according to the weight distribution of the tool parts on the tool head providing for maximum effectiveness. The hoe blade is shaped and sized for easy and rapid insertion into the soil providing for easy extraction of deeply rooted weeds without unnecessarily disrupting adjacent soil or damaging nearby plants.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates generally to garden tools and more particularly to a tool that functions as a rake and as a hoe.

The background information discussed below is presented to better illustrate the novelty of the present invention. This background information is not admitted prior art.

For early peoples, gardening was a means of survival. Today people still garden in order to grow food for their table, but many others garden for other reasons. Some garden to enjoy the challenges of working with nature, some people find making a garden to be esthetically pleasing, others garden to relax. Recently, gardening has become one of the more desirable forms of exercise. Gardening requires walking, bending, stooping, lifting, repeated getting up and down motions, carrying equipment, digging, and so forth. Even doctors are encouraging people to garden, especially when other forms of exercise are not feasible or desirable. Senior citizens, especially, find gardening to be an attractive alternative to the typical forms of exercise, such as jogging.

Regardless of the purpose for gardening, all gardeners rely on a variety of tools to prepare the garden soil at planting time, for weeding, and for removing garden litter, such as fallen leaves. While a number of power operated cultivating tools have been created through the years, a substantial amount of soil cultivation is still done by hand, for many reasons. Some people do not have outdoor accessible electric outlets, others feel that working with power tools involves too much risk of personal injury, and for some, power tools are too expensive.

The alternative to the use, of power tools in the garden is, of course, the use of manually powered, hand-held cultivating tools. Perhaps the most popular hand cultivating tools are rakes and hoes. While rakes come in a variety of forms, they typically include an elongated handle having a laterally positioned cross member which in turns supports a plurality of tines often arranged in a parallel array. A garden rake is called upon to perform many functions, from the raking leaves in the fall to smoothing and/or furrowing the soil in the spring. During the summer months, long-handled rakes are often relied on to cultivate the soil to a desired depth and/or to clean debris from the garden. For these uses, long-handled rakes usually perform quite adequately. However, there are occasions when other types of tools are required. Often, this need arises while the gardener is busy using the rake to cultivate the soil or remove garden debris. In fact, it is precisely while doing these jobs that a gardener is most likely to come across an undesirable, deep-rooted weed that has become so firmly entrenched in the soil that a hoe is required to uproot the offender. A hoe is somewhat similar to a rake, but differs in that a hoe usually comprises a planar blade in place of a plurality of tines. Rakes and hoes, however, are generally available as separate tool and while each such tool provides substantial benefit in cultivating soil and removing garden weeds and debris, their use often proves inconvenient in that more than one tool must be carried to and from the work location and then must be cleaned and carefully stored away from the work area to avoid injury to the gardener and/or others. In addition, substantial time is often lost in switching among such an array of cultivating tools. So, unless the gardener is well-organized and has thought in advance of bringing to the gardening area a hoe and a rake, another trip to the tool shed is required, taking effort and time. At times like these, it would be much appreciated to have a heavy duty, but light weight hoe and a rake combination tool, where the handle of the tool is balanced relative to each tool part to provide for the most effective use of the tool.

Another instance where another type of tool is required is when leaf litter or other types of vegetation debris has accumulated in heavily planted areas. This often happens when deciduous plants and shrubs lose their leaves in the fall and winter. During this time many leaves are blown into the garden and, while many gardeners allow the fallen leaves to remain in place over the winter to act as mulch, unless the gardener gets outside to rake before new growth starts, it soon hides much of last fall and winter's litter. Once the litter is covered by the new growth it is difficult to use a long handled rake without risking damage to the tender young plants by the heavy rake. The safest way to clear the soil around the tender spring shoots is for the gardener to kneel or stoop close to the ground so that he or she can see the short tips of new plant growth to avoid scraping them with the rake. Once near the ground however, it is very difficult, if not impossible, to use a long handled rake. It is clear then that what is sorely needed is a durable, effective, light-weight, short-handled hand rake.

Often, as mentioned above, a gardener uses a hoe for removing individual weeds. To do this a gardener inserts the hoe blade into the soil to a depth just below the weed's roots at which time the hoe handle is used to provide the leverage required to lift the securely rooted weeds free of the garden soil. This hoeing process, using a long handled hoe, works well for weeds that are both visually and physically accessible, such as when weeds are found between widely spaced plants or shrubs. However, when the weeds have seeded themselves between closely-spaced, more desired plants, the situation is different. Although the top growth of the weed is often painfully visible, the spot where the weed emerges from the ground in not visible as it is hidden by the foliage of the desirable plants. Simply pulling the weed using its upper foliage often tears the upper foliage away from the roots. This allows the weed's roots to remain in place, where they are now free to grower even larger and stronger, and thus more difficult to remove from the garden. Successful removal of weeds requires complete removal of the weed, roots and all. In order to accomplish this, the gardener must first move aside the foliage that is hiding the spot where the weed roots enter the ground and then must insert and position the hoe blade into that spot in the ground to remove the weed without harming the other plants. This job, however, is difficult if not impossible to accomplish using a long handled hoe. It is just too unwieldy to hold a long-handled hoe while bending over to move the foliage under which the weed roots can be found. In order to insert the hoe into the ground one must be standing which means that the gardener must let go of the foliage which recovers the weed's roots. At this point, the gardener is working blind and hoping that the hoe is positioned in the correct spot for the removal of the weed. If the hoe is not positioned correctly, there is a substantial risk that a prized plant will be removed, or at least damaged, instead of the weed being removed. The gardener knows, however, that this problem may be solved simply by getting down on his or her knees in which position the gardener may easily hold the foliage away from the weed and easily ascertain the correction position for inserting the hoe blade. But, kneeling, it is impossible for the gardener to manipulate the long-handed hoe. What is still missing from the art is a short-handled Rake-Hoe™ combination tool, for use when gardening near to the ground surface.

Yet another need among gardeners is for a tool that is light-weight, strong, and effective while being easy to use, even by even by those whose strength is limited, including senior citizens who are gardening in ever increasing numbers. Although many seniors are bothered by a variety of arthritic-like diseases that reduce their hand and arm strength and limit their muscular ability, they are interested in gardening for the many benefits obtained, including an improvement in the above mentioned disabilities, and thus, they need tools that they are able to use without undue exertion. To meet these needs, a tool should be light-weight, strong enough to do the job, and be maximally effective, which includes having the handle balanced relative to the tool's working head so that, maximum benefit may be derived even for minimal effort.

There remains, therefore, a need in the art for an improved long-handled and short-handled, sturdy, light-weight, balanced garden tool that is easy to use and effective, and which would provide the attributes of both a rake and a hoe to allow gardeners the use of a single tool where two were required previously. There have been some attempts to provide for such as tool, but until now there is none that can provide all of the desired attributes disclosed above.

Multiple use cultivating tools have been described, but all suffer from one or more deficiencies. One attempt at offering a multi-purpose tool features two pseudo rake parts, a hoe-like triangular part, and a very short, flat edged hoe part all extending from a planer sheet of metal. Instead of having the effective tines of a garden rake, however, the rake parts offer only triangularly-shaped “tines” of questionable strength and utility. Additionally, the generally planar triangular pseudo-tines are not curved as are the tines of a garden rake. Moreover, the space between what the inventor refers to as tines is the inverted triangular shape of the pseudo-tines, leaving little space for soil to pass through the tines, making furrowing and litter cleaning exceedingly difficult and time-consuming as the narrow passages would quickly become clogged with soil and/or garden litter. Each of the rakes and the pointed hoe of this implement are cut from a single planar piece of metal and thus are not structurally reinforced in any manner. Another structural deficiency comes from the fact that the handle of the device is held in place by a handle holding part that is simply welded onto one side of the planar sheet of metal from which the various parts extend. If any serious gardening efforts were made using this apparatus, it would not take long for the welded handle holder to become loosened and dislodged from the planar sheet. The lack of serious working tines, the very short straight-edged hoe, and the small triangularly shaped hoe part, combined with the insufficient means for attaching a handle to the plate from which the parts extend make this type of apparatus quite inadequate for the desired uses.

Another device is a structurally complex, multi-functional tool that includes separately attached shovel, rake, spade, and hoe elements. All of the tool elements are integrated into one seemingly rather heavy master tool, wherein each of the four separate functions may be accessed at any time in any order of desired priority or need. Two of the elements are attached to two pivotable arms that are positioned alongside the handle of the tool when the elements are not in use. The spade and hoe can be positioned in the notches on the head of the spade, when their use is desired, by bringing the pivotable arms down from their “in storage” position. The complexity of this tool, along with its many moveable parts, suggests a high manufacturing cost, as well as a high probability of damage to the many moveable parts and a concomitant need for parts replacement.

There are tools that offer detachable attached working parts, so that, for example, an otherwise standard rake may be converted, in effect, to a hoe for weeding, trimming, or similar operations. The problem with this invention is that if the fastener used to attach an attachment to the rake becomes loose, the attachment will no longer work, and in the worst case, the attachment will detach from the rake frame to become lost, causing considerable frustration especially when the gardening job to be done depends on the use of the lost part.

A combination garden tool, for which a short handle is available for the removal of weeds, digging or leveling of soil and planting has also been described. The weed removal part of the invention includes a set of generally parallel elongated tines with pointed ends, where the tines are spaced apart from each other to form a set of narrow V-shaped openings for engagement with weeds. These tines are too long to perform as a garden rake and were designed for, grabbing and pulling weeds, although the thinness of the tines and the large space between the tines makes this tool less than desirable for weed removal. Additionally, the hoe-like part consists only of a pointed attachment that cannot perform the same tasks as a straight-edged hoe would.

Accordingly, it would be a significant improvement in the art to provide for a tool that provides a handle that is balanced relative to the tools on the tool head of the implement so that use of the device is both effective and easy. The handle of the device should be available in both long and short models. Moreover, the device should provide, in one tool head, both raking and hoeing capabilities without the need to change individual tool heads or to add and/or delete parts.

### SUMMARY

The present invention satisfies the urgent need in the art for an effective, light weight, balanced, easy to use, short- and/or long-handled, garden tool device that provides both raking and hoeing capabilities from one tool head so that there is no need to change tool heads or to add and/or delete parts. The rake part of the tool head has an optional number of functional tines designed to till the soil to an appreciable depth. The hoe part of the tool head may be positioned on either end of the tool head. The handle, long or short, is balanced according to the weight distribution of the tool parts and the tool head. The hoe blade is shaped and sized for easy and rapid insertion into the soil to provide for the easy extraction of deeply rooted weeds without unnecessarily disrupting adjacent soil or damaging nearby plants. The rake tines are sized and arranged for maximum tilling and debris catching functionality.

If desired, Rake-Hoe™ devices are available having a hoe blade functionally positioned and attached to both ends of the tool head. When the Rake-Hoe™ has a hoe blade functionally positioned to both ends of the tool head, one hoe blade may be a traditional hoe blade, while the other hoe blade may be a forked, curved, or split hoe blade. When the other hoe blade is a forked or split hoe blade, gardeners have alternative means of removing weeds, for example, by using a pulling, instead of a digging, action.

One embodiment offers the Rake-Hoe™ combination device as a hand-held tool. The tool is strong, heavy duty device permitting easy ground penetration, but is light enough to prevent excessive muscle fatigue. If desired, the short, hand-held handle may be easily replaced by a longer handle that would enable the device to be used by a person when in a standing position or the device may be purchased in two versions, a short-handled and a long-handled. Having a long-handled tool is necessary for people who are unable to work in a kneeling position, such as a person who is afflicted with arthritis.

Regardless of whether the Rake-Hoe™ has one or more than one additional tool parts positioned on and attached to the tool head along with the rake part, the handle of the hoe-rake is attached to the tool head so that the handle is balanced with respect to the weight of the tool parts and the tool head. Balancing the handle in this manner ensures maximum transmission of the force exerted by a gardener to the tool part of the Rake-Hoe™.

All of these advances and advantages are made available by providing for a light-weight garden tool device, comprising:
a tool head having at least two tool parts integral with the tool head, wherein at least one of the tool parts is a hoe blade and at least one of the tool parts is a rake, and
a handle functionally attached to the tool head, the handle being weight-balanced relative to the weight of the tool head and the tool parts.

The light-weight garden tool device further comprising wherein the handle is a short handle or a long handle.

The light-weight garden tool device further comprising wherein the tool head further comprises a rake and at least two hoe blades.

The light-weight garden tool device further comprising a hoe blade that may be forked, curved, or is a split hoe blade.

The light-weight garden tool device further comprises a heavy duty, durable tool head that includes the working tool parts which are an integral (i.e., in one piece with) part of the tool head, made by any suitable molding technique, and may be manufactured of a suitably lightweight yet strong metal, such as steel.

Additionally, the light-weight garden tool device comprises making the handle using any suitably strong material including metal, such as steel, wood, and fiberglass.

Moreover, the tool head of the light-weight garden tool device may be attached to the handle of the device using known bow attachment means.

The present invention also contemplates a stake integral with said tool head, wherein the handle is attached to the stake.

In addition, the present invention also contemplates a light-weight garden tool device that comprises:
a substantially rectangular, planar tool head,
a rake functionally formed from and along the long side of the tool head,
a hoe blade functionally formed from and along an end of the tool head, and
a handle functionally attached to the tool head, wherein the handle is weight-balanced relative to the weight of the tool head of which the tool parts are a unitary part.

Moreover, the present invention contemplates a light-weight garden tool device that comprises:
a substantially rectangular, planar tool head,
a rake functionally formed from and along the length of the tool head,
a hoe blade functionally formed from and along an end of the tool head,
another tool part functionally formed along another end of the tool head, and
a handle functionally attached to the tool head and weight-balanced relative to the weight of the tool head and to the tool parts that are integrally formed with the tool head.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended, the invention will now be described, by way of example, with reference to the accompanying drawings, wherein like reference characters indicate like parts throughout the several figures, and in which:

FIG. 1 is a front plan-view of the Rake-Hoe™ head.

FIG. 2 is a plan view of the Rake-Hoe™ head as shown in FIG. 1 fixed to a handle ready for use.

### DEFINITIONS

Integral, as used herein, refers to a whole made up of parts, wherein the parts are formed as one unit and are all of one and the same piece.
Bow-rake, as used herein, refers to a rake wherein the rake head is attached to the rake handle by bow-like attachment pieces that are each attached to an opposite side of the rake handle and extend from that attachment point to a proximate end of the rake where they are also attached.
Hoe, as used herein, refers to an agricultural implement that often consists of a thin flat blade that sits transversely on a handle and is used especially for cultivating, weeding, or loosening the soil around plants or soil that is being readied for planting.
Stake, as used herein, refers to a means by which the tool head is inserted into, or united, with the handle. One such means may be a pointed piece of wood, metal, or other material designed to be into something, such as a stake on a tool head, which stake is designed to be driven into a handle piece for the purposes of securing the handle piece to the tool head. This means could be formed integrally with, and be a part of, the tool head. Another example might be a cylinder emanating from one edge of the tool head, where the cylinder is shaped for fitting into or around the handle shaft. Regardless of the design of the attachment means, it's presence maximizes the transfer of the force exerted by a gardener on the tool handle to the tool head's working parts, and to minimize any vibrations that may occur while the tool is in use.
Tool head, as used herein, refers to a relatively planar piece having working tools as part of one, several, or all of the edges of the piece, such as a rake tool part that is structurally configured to successfully accomplish the gardening chores of raking debris and/or tilling the soil.
Working tool parts, as used herein, refers to those parts of the tool head that are used to accomplish a particular job, such as a rake tool part for raking and tilling and a hoe blade part for hoeing and weeding.

### A LIST OF THE REFERENCE NUMBERS AND RELATED PARTS OF THE INVENTION

10 a Rake-Hoe™ tool head having a rake part and a hoe blade part
12 a rake part of Rake-Hoe™ head 10
14 a tine of rake part 12 of which tines there may be an optional number, of optional length, and of optional width
16 a hoe blade part of Rake-Hoe™ head 10
20 a Rake-Hoe™ tool ready for use
22 bow-means of attaching Rake-Hoe™ head 10 to Rake-Hoe™ handle 26
24 a stake unto which handle 26 is attached
26 a handle, which handle may be long or short

It should be understood that the drawings are not necessarily to scale. In certain instances, details which are not necessary for an understanding of the present invention or which render other details difficult to perceive may have been omitted. It should be understood, of course, that the invention is not limited to the particular embodiments illustrated herein, but encompasses many embodiments as are discussed throughout the specification.

### DETAILED DESCRIPTION

Referring now to the drawings that present exemplary embodiments of the present invention to demonstrate how the above mentioned disadvantages have been overcome. It should be noted that the disclosed invention is disposed in variations in size, shape, and form, such as wider or narrower Rake-Hoe™ heads, longer or shorter handles, one hoe blade or two, hoe blades of varying shape and function, made of different materials, and so forth, which will be discussed in more detail below. Therefore, the embodiments described herein are provided with the understanding that the present disclosure is intended as illustrative and is not intended to limit the invention to the embodiments described herein.

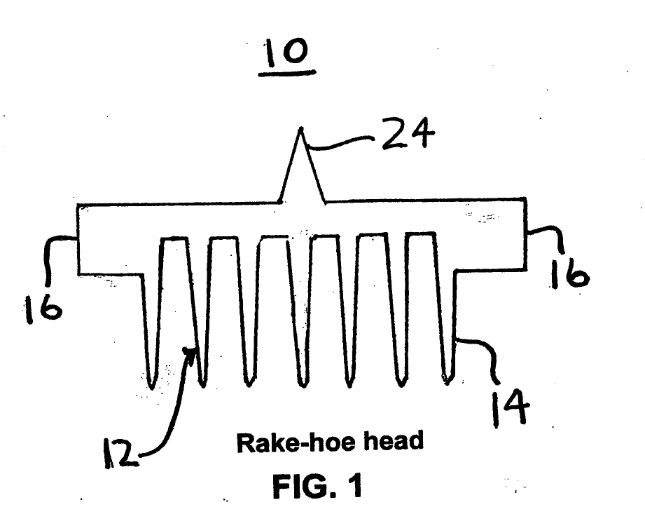

FIG. 1 presents a plan view of generally rectangular and planar-like Rake-Hoe™ head 10. It will be seen that the Rake-Hoe™ garden tool device as described herein provides a multi-use tool head having both raking and hoeing capabilities without the need to change individual tool heads or to add and/or delete parts, and a handle that is available in both long and short models, as desired and/or required by the job at hand. Moreover, the handle is positioned on the tool head so that it is weight balanced relative to the weight of the working tools and the tool head of which the working tools are a part so that the device is both effective and easy to use.

The shape and the planarity of Rake-Hoe™ tool head 10 may vary without departing from the scope of the invention. For example, the perimeter of Rake-Hoe™ tool head 10 may be more oval shaped instead of rectangular. Likewise, generally planar-like Rake-Hoe™ tool head 10 may be either curved planar or flat planar without departing from the scope of the invention. These structural modifications are chosen as desired according to the preference of the user and to the requirements of the job to be performed. FIG. 1 shows three working tools parts emanating from Rake-Hoe™ tool head 10, rake part 12 that is formed from and along one length of Rake-Hoe™ tool head 10. Rake part 12 and all other tool parts are formed integrally with tool head 10, that is, each working tool part is fashioned from the same piece of material from which tool head 10 is formed. Forming additional working tool parts from the same piece of material from which the tool head is formed is an especially economical method of manufacture adding only pennies to the cost of a multi-functional tool as compared to much higher manufacturing cost of multi-functional tools that offer several separate interchangeable parts. In addition, FIG. 1 shows tool head 10 with hoe blade working tool part 16 formed as a part of each end of Rake-Hoe™ head 10. It will be appreciated that other models of Rake-Hoe™ tool head 10 offer a hoe blade part on only one end Rake-Hoe™ head 10. Alternatively, Rake-Hoe™ tool head 10 may offer a hoe blade part on only one end Rake-Hoe™ tool head 10. Each hoe blade that, emanates from and is a part of Rake-Hoe™ head 10, may be fashioned into a typical flat hoe blade, a forked, curved, or split hoe blade, as desired. Rake part 12 has a variable number of tines 14 where the number of tines on each rake will be decided by which job the rake will be designed to do. The tines are of any desired length or width that is required to perform the jobs of raking and tilling. Also illustrated in FIG. 1 is one version of stake 24 for illustration purposes. The stake as shown is configured with a pointed end to receive the attachment end of a handle. Stake 24 is firmly and securely inserted into the attachment end of a handle to provide stability to the device when the device is in use. It should be understood that other attachments means are possible, such as a closed or an open cylinder that emanates from and is an integral part of the tool head. The cylinder may be functionally adapted for filling about the handle or, when the handle is hollow, the attachment cylinder may be fit inside of the handle. Primarily, the stake provides three functions. It provides strength and integrity to the handle/head attachment. The stake also allows for a maximum amount of the force exerted by a user to be transmitted to the working end of the device. Moreover, the extra support provided by the stake minimizes any vibration that may occur as the tool is used. If desired, securing bands may be place about the cylinder if the cylinder is such that it fits about the outside of the handle. Other additional means for securing the attachment means to the handle may also be employed, such as the use of small nails, tacks, staples, screws, or the like.

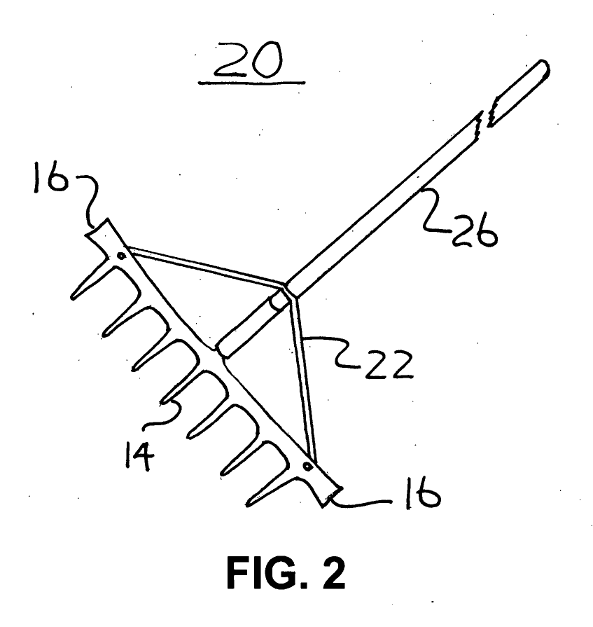

FIG. 2 shows Rake-Hoe™ tool device 20 ready for use in the garden with tool head 10 attached in part by stake 24 to handle 26. Handle 26 may be as long or short as desired. Regardless of the length of the handle or the number of working tool parts on tool head 10, handle 26 is positioned on the tool head so that it is weight-balanced relative to the weight of said tool head and said tool parts. Balancing the handle relative to the weight of the tool head and the working tool parts ensures maximum transmission of the force exerted by a gardener to the working tool parts of the Rake-Hoe™ device.

FIG. 2 also illustrates the addition of bow attachment means 22. The addition of bow attachment means 22 provides for more secure attachment of tool head 10 to handle 26. Failure of the attachment between tool heads and handles is an all too-common experience for gardeners especially when a garden tool is used to pry stones up out of the soil or to lift roots that are larger and more secure than most. The additional support made available by the use of bow attachment means 22 reduces the risk of Rake-Hoe™ tool head 10 becoming detached from handle 26. The additional support, made available by the use of bow attachment means 22, reduces the amount of vibration that is apt to occur during certain garden jobs, such as raking.

Tool head 10 of light-weight garden tool device 20 may be made by any suitable molding means using any known, or yet to be known, material capable of imparting the durability and toughness required by such garden tools as rakes and hoes while being light-weight. Such a known material may be a metal. One ideal metal would be steel.

The handle that is attached to the tool head may also may be made using a metal but may also be made of other materials, such as wood or fiberglass, which are also durable and light-weight.

The foregoing description, for purposes of explanation, used specific and defined nomenclature to provide a thorough understanding of the invention. However, it will be apparent to one skilled in the art that the specific details are not required in order to practice the invention. Thus, the foregoing description of the specific embodiments of the Rake-Hoe™ device is presented for purposes of illustration and description. They are not intended to be exhaustive or to limit the invention to the precise forms disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

1. A light-weight garden tool device, comprising:
a generally rectangular planar tool head having at least two working tool parts formed integrally with said tool head,
wherein at least one of said tool parts is a hoe blade and at least one of said tool parts said is a rake, and
a handle having:
a) a bow attachment means attached between and directly to both said tool head and said handle, said bow attachment means attaching said tool head to said handle, and
b) a stake attachment means attached between and directly to both said tool head and said handle, said stake attachment means attaching said tool head to said handle, said handle weight-balanced relative to the weight of said tool head and said tool parts.

2. The light-weight garden tool device as recited in claim 1, further comprising said tool head having at least one of said tool parts formed along each side of the tool head.

3. The light-weight garden tool device, as recited in claim 1, further comprising wherein said handle is a short handle.

4. The light-weight garden tool device, as recited in claim 1, further comprising wherein said handle is a long handle.

5. The light-weight garden tool device, as recited in claim 1, wherein said tool head further comprises a rake and at least two hoe blades.

6. The light-weight garden tool device, as recited in claim 1, further comprising wherein said hoe blade is forked.

7. The light-weight garden tool device, as recited in claim 1, further comprising wherein said hoe blade is curved.

8. The light-weight garden tool device, as recited in claim 1, further comprising wherein said hoe blade is a split hoe blade.

9. The light-weight garden tool device, as recited in claim 1, further comprising wherein said tool head is made by molding.

10. The light-weight garden tool device, as recited in claim 1, further comprising wherein said tool head is made or metal.

11. The light-weight garden tool device, as recited in claim 10, further comprising wherein said metal is steel.

12. The light-weight garden tool device, as recited in claim 1, further comprising wherein said handle is made with metal.

13. The light-weight garden tool device, as recited in claim 12, further comprising wherein said metal is steel.

14. The light-weight garden tool device, as recited in claim 1, further comprising wherein said handle is made with wood.

15. The light-weight garden tool device, as recited in claim 1, further comprising wherein said handle is made with fiberglass,

16. The light-weight garden tool device, as recited in claim 1, further comprising wherein said handle has a long axis.

17. The light-weight garden tool device, as recited in claim 16, further comprising wherein said said long axis of said handle is in a plane that is the same plane as the plane of said tool head.

18. (canceled)

19. A light-weight garden tool device, comprising:
a substantially rectangular, planar tool head,
a rake functionally formed along and integral to the length of said tool head.
a hoe blade functionally formed along and integral to an end of said tool head. and
a handle having a length, said handle functionally attached to said tool head,
said handle weight-balanced relative to the weight of said tool head and said tool parts,
wherein said planar tool head and said length of said handle are positioned within a same plane.

20. A light-weight garden tool device, comprising:
a substantially rectangular, planar tool head,
a rake functionally formed along and integral to the length of said tool head,
a hoe blade functionally formed along and integral to an end of said tool head,
a hoe blade functionally formed along and integral to another end of said tool head, and
a handle functionally attached to said tool head, said handle weight-balanced relative to the weight of said tool head and said tool parts wherein the plane of said planar tool head and said long axis of said handle are in a same plane.

21. The light-weight garden tool device, as recited in claim 19, further comprising;
a) a bow attachment means attached between and directly to both said tool head and to said handle, said bow attachment means attaching said tool head to said handle, and
b) a stake attachment means attached between and directly to both said tool head and to said handle, said stake attachment means attaching said tool head to said handle,
wherein said bow and said stake provide two means separate from each other of attaching said tool head to said handle.
